(19) United States
(12) Patent Application Publication
(10) Pub. No.: US 2021/0009892 A1
(43) Pub. Date: Jan. 14, 2021

(54) BETA-GLUCAN COMPOSITIONS INCLUDING SURFACTANT

(71) Applicant: CARGILL INCORPORATED, Wayzata, MN (US)

(72) Inventor: Jeffrey J. MALSAM, Minneapolis, MN (US)

(73) Assignee: CARGILL INCORPORATED, Wayzata, MN (US)

(21) Appl. No.: 16/499,743

(22) PCT Filed: Mar. 27, 2018
(86) PCT No.: PCT/US2018/024449

§ 371 Date: Sep. 30, 2019

Related U.S. Application Data
(60) Provisional application No. 62/477,652, filed on Mar. 28, 2017.

(51) Int. Cl. C09K 8/90; C08L 5/00; C08B 37/00

(52) U.S. Cl. CPC C09K 8/905; C08B 37/0024; C08L 5/00

(57) ABSTRACT

Beta-glucan compositions including surfactants and methods of using the same, such as for treatment of subterranean formations. An aqueous beta-glucan composition includes a beta-glucan and a surfactant.

### BACKGROUND

Beta-glucans can be used as thickeners in aqueous fluids for treatment of subterranean formations, such as for enhanced oil recovery (EOR). Conventional beta-glucan compositions experience phase separation and precipitation under the conditions of the subterranean formation. Under subterranean conditions, conventional salt water-based beta-glucan compositions can experience phase separation or precipitation, or can have an oil or water solubilization ratios (i.e., volume of oil or water solubilized divided by the volume of surfactant) of less than 10, either or both of which can result in inefficient or ineffective treatment of the subterranean formation.

### SUMMARY OF THE INVENTION

Various aspects of the present invention provide an aqueous beta-glucan composition including a beta-glucan and a surfactant.

Various aspects of the present invention provide an aqueous beta-glucan composition that includes a beta-glucan that is about 0.001 wt % to about 5 wt % of the composition. The composition includes one or more surfactants, including an anionic surfactant, that together about 0.01 wt % to about 5 wt % of the composition. The composition includes salt water that is about 88 wt % to about 99 wt % of the composition. The composition has a total dissolved solids level about 40,000 ppm to about 200,000 ppm. At a temperature of at least one of 52° C. and 92° C., the composition is substantially free of phase separation and haziness according to visual detection for at least about 14 days. At a temperature of at least one of 52° C. and 92° C., and in an emulsion with crude oil, the composition has an oil solubilization ratio of 10 or more, or a water solubilization water of 10 or more, or both.

Various aspects of the present invention provide an aqueous beta-glucan composition including scleroglucan that is about 0.04 wt % to about 0.08 wt % of the composition. The composition includes one or more surfactants, including an anionic surfactant, that together are about 0.5 wt % to about 3 wt % of the composition. The composition includes salt water that is about 97 wt % to about 99 wt % of the composition. The composition has a pH of about 7 to about 8.5. The composition has a total dissolved solids level of about 46,000 ppm to about 71,000 ppm. At a temperature of at least one of 52° C. and 92° C., and in an emulsion with crude oil, the composition has an oil solubilization ratio of 10 or more, or a water solubilization water of 10 or more, or both.

Various aspects of the present invention provide an aqueous beta-glucan composition including scleroglucan that is about 0.04 wt % to about 0.08 wt % of the composition. The composition includes one or more surfactants, including an anionic surfactant, that together are about 0.5 wt % to about 3 wt % of the composition. The composition includes salt water that is about 97 wt % to about 99 wt % of the composition. The composition has a pH of about 10 to about 11. The composition has a total dissolved solids level of about 61,000 ppm to about 66,000 ppm. At 92° C. and in an emulsion with crude oil the composition has an oil solubilization ratio of 10 or more, or a water solubilization water of 10 or more.

Various aspects of the present invention provide a method of treating a subterranean formation. The method includes placing the aqueous beta-glucan composition described herein in the subterranean formation. The aqueous beta-glucan composition can include a beta-glucan and a surfactant.

Various aspects of the present invention can provide certain advantages over other compositions including beta-glucans and surfactant and methods of using the same, at least some of which are unexpected. For example, in various aspects, the beta-glucan composition can be an effective and efficient fluid for surfactant flooding of subterranean formations (e g , enhanced oil recovery) at a different or broader range of salinities than other compositions, such as by avoiding precipitation or phase separation under subterranean conditions, by providing higher oil or water solubilization ratios (e.g., greater than 10), or a combination thereof.

Some subterranean formation treatment fluids can clog pores and flowpaths in subterranean formations which can result in decreased production rates or increased pressures that can damage the formation. In various aspects, the aqueous beta-glucan composition of the present invention can provide higher filterability (e.g., less clogging of pores in a subterranean formation as the composition flows therethrough) than solutions made with other beta-glucans. In various aspects, the beta-glucan composition of the present invention can maintain viscosity more effectively during various filtration procedures, such as various procedures for treatment of a subterranean formation, as compared to solutions formed with other beta-glucans.

### BRIEF DESCRIPTION OF THE FIGURES

The drawings illustrate generally, by way of example, but not by way of limitation, various aspects of the present invention.

FIG. 1 illustrates viscosity versus concentration for scleroglucan, in accordance with various aspects.

FIG. 2 illustrates viscosity versus concentration for modified-HPAM, in accordance with various aspects.

FIG. 3 illustrates extrapolated viscosity versus scleroglucan concentration in a soft brine, in accordance with various aspects.

FIG. 4 illustrates extrapolated viscosity versus modified-HPAM concentration in a soft brine, in accordance with various aspects.

FIG. 5A illustrates aqueous stability of a surfactant formulation with no polymer after 3.5 weeks, in accordance with various aspects.

FIG. 5B illustrates aqueous stability of a surfactant formulation with scleroglucan after 2 weeks, in accordance with various aspects.

FIG. 5C illustrates aqueous stability of a surfactant formulation with modified-HPAM after 2 weeks, in accordance with various aspects.

FIG. 5D illustrates aqueous stability of a surfactant formulation with no polymer after 2 weeks (left) with haziness coming from the etched glass (right), in accordance with various aspects.

FIG. 5E illustrates aqueous stability of a surfactant formulation with scleroglucan after 2 weeks (top), with haziness coming from the etched glass (bottom), in accordance with various aspects.

FIG. 5F illustrates aqueous stability of a surfactant formulation with modified-HPAM after 2 weeks (left), with haziness coming from the etched glass (right), in accordance with various aspects.

FIG. 6 illustrates solubilization ratio versus TDS for a surfactant formulation without polymer, in accordance with various aspects.

FIG. 7 illustrates solubilization ratio versus TDS for a surfactant formulation with scleroglucan, in accordance with various aspects.

FIG. 8 illustrates solubilization ratio versus TDS for a surfactant formulation with modified-HPAM, in accordance with various aspects.

FIG. 9 illustrates solubilization ratio versus TDS for a surfactant formulation with varying amounts and types of viscosifier therein, in accordance with various aspects.

FIG. 10 illustrates solubilization ratio versus TDS for a surfactant formulation without polymer, in accordance with various aspects.

FIG. 11 illustrates solubilization ratio versus TDS for a surfactant formulation with scleroglucan, in accordance with various aspects.

FIG. 12 illustrates solubilization ratio versus TDS for a surfactant formulation with modified-HPAM, in accordance with various aspects.

FIG. 13 illustrates solubilization ratio versus TDS for a surfactant formulation with various types and amounts of viscosifier, in accordance with various aspects.

FIG. 14 illustrates solubilization versus TDS for a surfactant formulation with no polymer, in accordance with various aspects.

FIG. 15 illustrates solubilization versus TDS for a surfactant formulation with scleroglucan, in accordance with various aspects.

FIG. 16 illustrates solubilization versus TDS for a surfactant formulation with modified-HPAM, in accordance with various aspects.

FIG. 17 illustrates solubilization versus TDS for a surfactant formulation various amounts and types of viscosifier, in accordance with various aspects.

### DETAILED DESCRIPTION OF THE INVENTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. All publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that the composition is about 0 wt % to about 5 wt % of the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less. The term “substantially free of” can mean having a trivial amount of, such that a composition is about 0 wt % to about 5 wt % of the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

The term “standard temperature and pressure” as used herein refers to 20° C. and 101 kPa.

The term “downhole” as used herein refers to under the surface of the earth, such as a location within or fluidly connected to a wellbore.

As used herein, the term “subterranean material” or “subterranean formation” refers to any material under the surface of the earth, including under the surface of the bottom of the ocean. For example, a subterranean formation or material can be any section of a wellbore and any section of a subterranean petroleum- or water-producing formation or region in fluid contact with the wellbore. Placing a material in a subterranean formation can include contacting the material with any section of a wellbore or with any subterranean region in fluid contact therewith. Subterranean materials can include any materials placed into the wellbore such as cement, drill shafts, liners, tubing, casing, or screens; placing a material in a subterranean formation can include contacting with such subterranean materials. In some examples, a subterranean formation or material can be any below-ground region that can produce liquid or gaseous petroleum materials, water, or any section below-ground in fluid contact therewith. For example, a subterranean formation or material can be at least one of an area desired to be fractured, a fracture or an area surrounding a fracture, and a flow pathway or an area surrounding a flow pathway, wherein a fracture or a flow pathway can be optionally fluidly connected to a subterranean petroleum- or water-producing region, directly or through one or more fractures or flow pathways.

As used herein, “treatment of a subterranean formation” can include any activity directed to extraction of water or petroleum materials from a subterranean petroleum- or water-producing formation or region, for example, including drilling, stimulation, hydraulic fracturing, clean-up, acidizing, completion, cementing, remedial treatment, abandonment, water shut-off, conformance, and the like.

As used herein, a “flow pathway” downhole can include any suitable subterranean flow pathway through which two subterranean locations are in fluid connection. The flow pathway can be sufficient for petroleum or water to flow from one subterranean location to the wellbore or vice-versa. A flow pathway can include at least one of a hydraulic fracture, and a fluid connection across a screen, across gravel pack, across proppant, including across resin-bonded proppant or proppant deposited in a fracture, and across sand. A flow pathway can include a natural subterranean passageway through which fluids can flow. In some aspects, a flow pathway can be a water source and can include water. In some aspects, a flow pathway can be a petroleum source and can include petroleum. In some aspects, a flow pathway can be sufficient to divert from a wellbore, fracture, or flow pathway connected thereto at least one of water, a downhole fluid, or a produced hydrocarbon.

### Aqueous Beta-Glucan Composition.

Various aspects of the present invention provide an aqueous beta-glucan composition. The aqueous beta-glucan composition can include a beta-glucan (e.g., one or more beta-glucans) and a surfactant (e.g., one or more surfactants). The composition can be characterized by any one or more of the features described herein.

The beta-glucan in the composition can be such that a 780 ppm mixture of the the beta-glucan in a salt water having a total dissolved solids level of about 67,500 ppm at 92° C. and 7.3 s⁻¹ has a viscosity of about 5 cP to about 15 CP, or about 8 cP to about 10 cP, or about 9 cP. The beta-glucan in the composition can be such that a 520 ppm mixture of the beta-glucan in a salt water having a total dissolved solids level of 33,100 ppm at 52° C. and 10 s⁻¹ has a viscosity of about 5 cP to about 15 CP, or about 8 cP to about 10 cP, or about 8 cP. As used herein, “ppm” refers to parts per million by mass unless otherwise specified.

The beta-glucan composition can have any suitable pH. The pH of the composition can be about 2 to about 11, about 7 to about 8.5, about 10 to about 11, or about 2 or less, or less than, equal to, or greater than about 3, 4, 5, 6, 7, 8, 9, 10, or about 11 or more.

The aqueous beta-glucan composition can have any suitable stability (e.g., aqueous stability), such as determined via visual absence of phase separation and haziness (e.g., precipitation) over time. For example, the aqueous beta-glucan composition can be a salt water composition, wherein at a concentration of the beta-glucan of about 780 ppm and at 92° C. for at least about 14 days the composition is substantially free of phase separation and haziness according to visual detection for a total dissolved solids level up to about 30,000 ppm to about 300,000 ppm, up to about 46,000 ppm to about 200,000 ppm, or up to about 30,000 ppm or less, or up to less than, equal to, or up to greater than about 40,000 ppm, 50,000, 60,000, 70,000, 80,000, 90,000, 100,000, 110,000, 120,000, 140,000, 160,000, 180,000, 200,000, 220,000, 240,000, 260,000, 280,000 ppm, or about 300,000 ppm or more. The aqueous beta-glucan composition can be a salt water composition having a pH of about 7 to about 8.5, wherein at a concentration of the beta-glucan of about 780 ppm and at 92° C. for at least about 14 days the composition is substantially free of phase separation and haziness according to visual detection for a total dissolved solids level up to about 30,000 ppm to about 60,000 ppm, up to about 46,000 ppm, or up to about 30,000 ppm or less, or up to less than, equal to, or up to greater than about 35,000 ppm, 40,000, 41,000, 42,000, 43,000, 44,000, 45,000, 46,000, 47,000, 48,000, 49,000, 50,000, 55,000 ppm, or about 60,000 ppm or more. The aqueous beta-glucan composition can be an alkaline salt water composition having a pH of about 10 to about 11, wherein at a concentration of the beta-glucan of about 780 ppm and at 92° C. for at least about 14 days the composition is substantially free of phase separation and haziness according to visual detection for a total dissolved solids level up to about 50,000 ppm to about 300,000 ppm or more, or up to about 96,000 ppm to about 200,000 ppm, or up to greater than 96,000 ppm, or up to about 50,000 ppm or less, or up to less than, equal to, or up to greater than about 60,000, 70,000, 80,000, 90,000, 100,000, 120,000, 140,000, 160,000, 180,000, 200,000, 220,000, 240,000, 260,000, 280,000 ppm, or about 300,000 ppm or more.

The aqueous beta-glucan composition can be a salt water composition, wherein at a concentration of the beta-glucan of about 520 ppm and at 52° C. for at least about 14 days the composition is substantially free of phase separation and haziness according to visual detection for a total dissolved solids level up to about 40,000 ppm to about 110,000 ppm, up to about 60,000 ppm to about 90,000 ppm or up to about 40,000 ppm or less, or up to less than, equal to, or up to greater than about 50,000 ppm, 60,000, 70,000, 80,000, 90,000, 100,000 ppm, or about 110,000 ppm or more. The aqueous beta-glucan composition can be a salt water composition having a pH of about 7 to about 8.5, wherein at a concentration of the beta-glucan of about 520 ppm and at 52° C. for at least about 14 days the composition is substantially free of phase separation and haziness according to visual detection for a total dissolved solids level up to about 40,000 ppm to about 80,000 ppm, up to about 60,000 ppm, or up to about 40,000 ppm or less, or up to less than, equal to, or up to greater than about 45,000 ppm, 50,000, 55,000, 60,000, 65,000, 70,000, 75,000 ppm, or up to about 80,000 ppm or more. The aqueous beta-glucan composition can be an alkaline a salt water composition having a pH of about 10 to about 11, wherein at a concentration of the beta-glucan of about 520 ppm and at 52° C. for at least about 14 days the composition is substantially free of phase separation and haziness according to visual detection for a total dissolved solids level up to about 70,000 ppm to about 110,000 ppm, up to about 90,000 ppm, or up to about 70,000 ppm or less, or up to less than, equal to, or up to greater than about 75,000 ppm, 80,000, 85,000, 90,000, 95,000, 100,000, 105,000 ppm, or about 110,000 ppm or more.

The aqueous beta-glucan composition can have any suitable oil solubilization ratio, i.e., the volume of oil solubilized in a microemulsion with oil divided by the volume of surfactant in the microemulsion. The aqueous beta-glucan composition can have any suitable water solubilization ratio, i.e., the volume of water solubilized in a microemulsion with oil divided by the volume of surfactant in the microemulsion. The aqueous beta-glucan composition can be a salt water composition, wherein at a concentration of the beta-glucan of about 780 ppm and at 92° C. and in an emulsion with crude oil the composition has an oil solubilization ratio that is equal to a water solubilization ratio of the composition at a total dissolved solids level of about 55,000 ppm to about 75,000 ppm, or about 63,000 ppm to about 65,000 ppm, or about 55,000 ppm or less, or less than, equal to, or about 58,000, 60,000, 61,000, 62,000, 63,000, 64,000, 65,000, 66,000, 67,000, 68,000, 69,000, 70,000, 72,000 ppm, or about 75,000 ppm or more (e.g., wherein the oil solubilization ratio is equal to the water solubilization ratio for at least one ppm total dissolved solids level within the range). The aqueous beta-glucan composition can be a salt water composition, wherein at a concentration of the beta-glucan of about 780 ppm and at 92° C. and in an emulsion with crude oil the composition has an oil solubilization ratio of 10 or more, or a water solubilization water of 10 or more, or both, at a total dissolved solids level of about 61,000 ppm to about 71,000 ppm, or about 61,000 ppm or less, or less than, equal to, or greater than about 62,000 ppm, 63,000, 64,000, 65,000, 66,000, 67,000, 68,000, 69,000, 70,000 ppm, or about 71,000 ppm or more. The aqueous beta-glucan composition can be a salt water composition having a pH of about 7 to about 8.5, wherein at a concentration of the beta-glucan of about 780 ppm and at 92° C. and in an emulsion with crude oil the composition has an oil solubilization ratio that is equal to a water solubilization ratio of the composition at a total dissolved solids level of about 60,000 ppm to about 70,000 ppm, about 64,000 ppm to about 65,000 ppm, or about 60,000 ppm or less, or less than, equal to, or greater than about 61,000 ppm, 62,000, 63,000, 64,000, 65,000, 66,000, 67,000, 68,000, 69,000 ppm, or about 70,000 ppm or more. The aqueous beta-glucan composition can be a salt water composition having a pH of about 7 to about 8.5, wherein at a concentration of the beta-glucan of about 780 ppm and at 92° C. and in an emulsion with crude oil the composition has an oil solubilization ratio of 10 or more, or a water solubilization water of 10 or more, or both, at a total dissolved solids level of about 62,000 ppm to about 71,000 ppm, or about 62,000 ppm or less, or less than, equal to, or greater than about 63,000 ppm, 64,000, 65,000, 66,000, 67,000, 68,000, 69,000, 70,000 ppm, or about 71,000 ppm or more.

The aqueous beta-glucan composition can be an alkaline salt water composition having a pH of about 10 to about 11, wherein at a concentration of the beta-glucan of about 780 ppm and at 92° C. and in an emulsion with crude oil the composition has an oil solubilization ratio that is equal to a water solubilization ratio of the composition at a total dissolved solids level of about 60,000 ppm to about 70,000 ppm, about 63,000 ppm, or about 60,000 ppm or less, or less than, equal to, or greater than about 61,000 ppm, 62,000, 63,000, 64,000, 65,000, 66,000, 67,000, 68,000, 69,000 ppm, or about 70,000 ppm or more. The aqueous beta-glucan composition can an alkaline salt water composition having a pH of about 10 to about 11, wherein at a concentration of the beta-glucan of about 780 ppm and at 92° C. and in an emulsion with crude oil the composition has an oil solubilization ratio of 10 or more, or a water solubilization water of 10 or more, or both, at a total dissolved solids level of about 61,000 ppm to about 66,000 ppm, or about 61,000 ppm or less, or less than, equal to, or greater than about 61,500 ppm, 62,000, 62,500, 63,000, 63,500, 64,000, 64,500, 65,000, 65,500 ppm, or about 66,000 ppm or more.

The aqueous beta-glucan composition can be a salt water composition, such as having a pH of about 7 to about 8.5, wherein at a concentration of the beta-glucan of about 520 ppm and at 52° C. and in an emulsion with crude oil the composition has an oil solubilization ratio that is equal to a water solubilization ratio of the composition at a total dissolved solids level of about 40,000 ppm to about 55,000 ppm, about 46,000 ppm to about 48,000 ppm, or about 40,000 ppm or less, or less than, equal to, or greater than about 41,000 ppm, 42,000, 43,000, 44,000, 45,000, 46,000, 47,000, 48,000, 49,000, 50,000, 51,000, 52,000, 53,000, 54,000 ppm, or about 55,000 ppm or more. The aqueous beta-glucan composition can be a salt water composition, such as having a pH of about 7 to about 8.5, wherein at a concentration of the beta-glucan of about 520 ppm and at 52° C. and in an emulsion with crude oil the composition has an oil solubilization ratio of 10 or more, or a water solubilization water of 10 or more, or both, at a total dissolved solids level of about 46,000 ppm to about 48,000 ppm, or about 46,000 ppm or less, or less than, equal to, or greater than about 46,200 ppm, 46,400, 46,600, 46,800, 47,000, 47,200, 47,400, 47,600, 47,800 ppm, or about 48,000 ppm or more.

Water can be any suitable proportion of the aqueous beta-glucan composition. Water can be about 70 wt % to about 99.9 wt % of the composition, about 97 wt % to about 99 wt % of the composition, or about 70 wt % or less, or less than, equal to, or greater than about 72 wt %, 74, 76, 78, 80, 82, 84, 86, 88, 90, 91, 92, 93, 94, 95, 96, 97, 97.5, 98, 98.5, 99, 99.5, 99.9 wt %, or about 99.99 wt % or more. The water can include fresh water, salt water, brine, produced water, flowback water, brackish water, sea water, synthetic sea water, or a combination thereof. For a salt water, the one or more salts therein can be any suitable salt, such as at least one of NaBr, CaCl₂, CaBr₂, ZnBr₂, KCl, NaCl, a carbonate salt, a sulfonate salt, sulfite salts, sulfide salts, a phosphate salt, a phosphonate salt, a magnesium salt, a sodium salt, a calcium salt, a bromide salt, a formate salt, an acetate salt, a nitrate salt, or a combination thereof. The water can include or be free of any suitable ion, such as Ca²⁺, Mg²⁺, K⁺, Na⁺, HCO₃⁻, Cl³¹ , SO₄⁻², or any combination thereof. The water can have any suitable total dissolved solids level, such as about 1,000 mg/L to about 250,000 mg/L, or about 1,000 mg/L or less, or about 0 mg/L, or about 5,000 mg/L, 10,000, 15,000, 20,000, 25,000, 30,000, 40,000, 50,000, 75,000, 100,000, 125,000, 150,000, 175,000, 200,000, 225,000, or about 250,000 mg/L or more. In some examples, the water can have a concentration of at least one of NaBr, CaCl₂, CaBr₂, ZnBr₂, KCl, and NaCl of about 0.1% w/v to about 20% w/v, or about 0%, or about 0.1% w/v or less, or about 0.5% w/v, 1, 2, 3, 4, 5, 6, 7, 8, 9, 10, 11, 12, 13, 14, 15, 16, 17, 18, 19, 20, 21, 22, 23, 24, 25, 26, 27, 28, 29, or about 30% w/v or more. The composition (i.e., the water) can have any suitable total dissolved solids level (i.e., salt concentration), such as about 0 ppm to about 300,000 ppm, or about 40,000 ppm to about 2000,000 ppm, or about 46,000 ppm to about 71,000 ppm, or about 0 ppm, or about 1,000 ppm or less, or less than, equal to, or greater than about 5,000 ppm, 10,000, 15,000, 20,000, 25,000, 30,000, 40,000, 50,000, 75,000, 100,000, 125,000, 150,000, 175,000, 200,000, 225,000, 250,000, 275,000 ppm, or about 300,000 ppm or more.

The beta-glucan can include one or more organic solvents. The one or more organic solvents can be about 0.001 wt % to about 10 wt % of the composition, about 0.5 wt % to about 1.5 wt % of the composition, or about 0.001 wt % or less, or less than, equal to, or greater than about 0.01 wt %, 0.1, 0.2, 0.3, 0.4, 0.6, 0.7, 0.8, 0.9, 1, 1.1, 1.2, 1.3, 1.4, 1.5, 1.6, 1.8, 2, 3, 4, 5, 6, 8 wt %, or about 10 wt % or more. The organic solvent can be any suitable organic solvent. The organic solvent can be miscible with water, or immiscible with water. The organic solvent can be an alcohol, an alpha-hydroxy acid alkyl ester, a polyalkylene glycol alkyl ether, or a combination thereof. The organic solvent can be an alcohol having a poly(alkylene oxide) group added to the —OH oxygen atom thereof, such as an ethoxylated isobutanol, such as isobutanol-10EO.

The composition can include one beta-glucan, or more than one beta-glucan. The one or more beta-glucans can be substantially homogeneously distributed in the composition. The one or more beta-glucans can form any suitable proportion of the composition, such as about 0.001 wt % to about 5 wt %, or about 0.01 wt % to about 0.1 wt %, or about 0.04 wt % to about 0.08 wt %, or about 0.001 wt % or less, or less than, equal to, or greater than about 0.01 wt %, 0.02, 0.03, 0.04, 0.05, 0.06, 0.07, 0.08, 0.09, 1, 1.1, 1.2, 1.3, 1.4, 1.5, 1.6, 1.7, 1.8, 1.9, 2, 2.2, 2.4, 2.6, 2.8, 3, 3.5, 4, 4.5 wt %, or about 5 wt % or more. The beta-glucan can be fully dissolved in the composition, such that no presence of undissolved material can be detected visually. The beta-glucan can be a 1,3 beta-glucan. The beta-glucan can be a 1,3-1,6 beta-D-glucan. The beta-glucan can be a 1,3-1,4 beta-D-glucan, such as having a main chain from beta-1,3-glycosidically bonded glucose units, and side groups which are formed from glucose units and are beta-1,6-glycosidically bonded thereto. Examples of such 1,3 beta-D-glucans include curdlan (a homopolymer of beta-(1,3)-linked D-glucose residues produced from, e.g., Agrobacterium spp.), grifolan (a branched beta-(1,3)-D-glucan produced from, e.g., the fungus Grifola frondosa), lentinan (a branched beta-(1,3)-D-glucan having two glucose branches attached at each fifth glucose residue of the beta-(1,3)-backbone produces from, e.g., the fungus Lentinus eeodes), schizophyllan (a branched beta-(1,3)-D-glucan having one glucose branch for every third glucose residue in the beta-(1,3)-backbone produced from, e.g., the fungus Schizophyllan commune), scleroglucan (a branched beta-(1,3)-D-glucan with one out of three glucose molecules of the beta-(1,3)-backbone being linked to a side D-glucose unit by a (1,6)-beta bond produced from, e.g., fungi of the Sclerotium spp.), SSG (a highly branched beta-(1,3)-glucan produced from, e.g., the fungus Sclerotinia sclerotiorum), soluble glucans from yeast (a beta-(1,3)-D-glucan with beta-(1,6)-linked side groups produced from, e.g., Saccharomyces cerevisiae), laminarin (a beta-(1,3)-glucan with beta-(1,3)-glucan and beta-(1,6)-glucan side groups produced from, e.g., the brown algae Laminaria digitata), and cereal glucans such as barley beta glucans (linear beta-(1,3)(1,4)-D-glucan produced from, e.g., Hordeum vulgare, Avena sativa, or Triticum vulgare).

The beta-glucan can be scleroglucan, a branched beta-glucan with one out of three glucose molecules of the beta-(1,3)-backbone being linked to a side D-glucose unit by a (1,6)-beta bond produced from, e.g., fungi of the Sclerotium. The beta-glucan can be schizophyllan, a branched beta-glucan having one glucose branch for every third glucose residue in the beta-(1,3)-backbone produced from, e.g., the fungus Schizophyllan commune. Fungal strains that secrete such glucans are known to those skilled in the art. Examples include Schizophyllum commune, Sclerotium rolfsii, Sclerotium glucanicum, Monilinla fructigena, Lentinula edodes, or Botrygs cinera. The beta-glucan can have desirable characteristics for treatment of subterranean formations as described in co-pending patent applications U.S. Provisional Application Ser. Nos. 62/313,973, 62/313,988, 62/345,109, and 62/348,278, and U.S. Patent Publication No. 2012/0205099.

The beta-glucan composition can include one surfactant or more than one surfactant. The one or more surfactants can be any suitable proportion of the composition, such as about 0.01 wt % to about 5 wt % of the composition, about 0.5 wt % to about 1.5 wt %, or about 0.01 wt % or less, or less than, equal to, or greater than about 0.05 wt %, 0.1, 0.2, 0.3, 0.5, 0.6, 0.7, 0.8, 0.9, 1, 1.1, 1.2, 1.3, 1.4, 1.5, 1.6, 1.7, 1.8, 1.9, 2, 2.2, 2.4, 2.6, 2.8, 3, 3.5, 4, 4.5, or about 5 wt % or more. The one or more surfactants can be chosen from an anionic surfactant, a cationic surfactant, or a nonionic surfactant, or a combination thereof. The composition can include an anionic surfactant. Anionic surfactants are desirable because of their strong surfactant properties, they are relatively stable, they exhibit relatively low adsorption on reservoir rock, and can be manufactured economically. Typical anionic surfactants are sulfates for low temperature EOR applications and sulfonates, and more specifically sulfonated hydrocarbons, for high temperature EOR applications. Crude oil sulfonates can be a product wherein a crude oil is sulfonated after it has been topped, petroleum sulfonates can be a product wherein an intermediate-molecular-weight refinery stream is sulfonated, and synthetic sulfonates can be a product wherein a relatively purse organic compound is sulfonated. These are all examples of surfactants that may be used herein. Cationic and nonionic surfactants can also be used, such as to improve the behavior of surfactant systems. The surfactant can be an (C₅-C₅₀)hydrocarbyl-poly((C₂-C₃)alkylene oxide) carboxylate (an anionic surfactant), such as oleyl-45PO-20EO carboxylate. The surfactant can be an internal olefin sulfonate (e.g., an anionic surfactant), such as Enordet O332 available from Shell Chemical or Enordet O342 available from Shell Chemical.

### Method of Treating a Subterranean Formation.

The present invention provides a method of treating a subterranean formation. The method can include placing the beta-glucan composition described herein in the subterranean formation. As used herein, placing a composition in a subterranean formation can designate transporting the composition from above-surface to the subterranean formation, or can designate forming the composition within the subterranean formation. For example, placing the beta-glucan composition in the subterranean formation can designate providing the beta-glucan composition above surface and placing it downhole into the subterranean formation, or it can designate forming the prepared beta-glucan composition in the subterranean formation, such as by adding a concentrated beta-glucan to an aqueous liquid or such as by increasing the total dissolved solids level of an aqueous solution including the beta-glucan downhole.

The method of treating the subterranean formation can include performing enhanced oil recovery (e.g., using the beta-glucan composition as a surfactant flood fluid or sweep fluid), hydraulic fracturing, water shut-off, conformance, or a combination thereof. In a hydraulic fracturing operation, the beta-glucan composition can be used during any suitable stage of the hydraulic fracturing, such as during at least one of a pre-pad stage (e.g., during injection of water with no proppant, and additionally optionally mid- to low-strength acid), a pad stage (e.g., during injection of fluid only with no proppant, with some viscosifier, such as to begin to break into an area and initiate fractures to produce sufficient penetration and width to allow proppant-laden later stages to enter), or at a slurry stage of the fracturing (e.g., as viscous fluid including proppant).

Performing enhanced oil recovery in the subterranean formation can include using the beta-glucan composition as a surfactant flooding fluid to sweep petroleum in the subterranean formation toward a well (e.g., a different well than the beta-glucan composition or a precursor thereto was injected into). The method can include removing the petroleum (e.g., at least some of the petroleum swept toward the well) from the well.

### EXAMPLES

Various aspects of the present invention can be better understood by reference to the following Examples which are offered by way of illustration. The present invention is not limited to the Examples given herein.

### Part I. Beta-Glucan Preparation.

### Example I-1. Beta-Glucan Preparation from Commercial Material

Using a 5000 liter jacketed vessel with moderate agitation, 7 g/L of commercial Actigum® CS6 from Cargill (crude powder blend of scleroglucan and sclerotium rolfsii organism powder) was added to 2400 liters of 11.8° C. water and mixed for 1 hour. After an hour of mixing, the vessel was heated to 85° C. and left under agitation for 12 hours without temperature control. After 12 hours the temperature was 41.3° C. and the vessel was reheated to 80° C. and passed through a Guerin homogenizer at 200 bar of pressure and 300 L/hr.

The homogenized mixture was cooled to 50° C. 4 g/L of CaCl₂*2H₂O was added. pH was reduced to 1.81 using 20% HCl. This mixture was agitated for 30 minutes to enable precipitation of oxalic acid (i.e., as calcium oxalate).

After maturation, the solution was adjusted back to 5.62 pH using 10% Na₂CO₃ and heated to 85° C. and left under agitation without temperature control for 14 hours, then reheated to 80° C.

After reaching 80° C. 20 g/L of Dicalite 4158 filter aid (water permeability 1.4 Darcies to 3.8 Darcies) was added to the vessel and mixed for 10 minutes.

After mixing, the solution was fed to a clean Choquenet 12 m² press filter with Sefar Fyltris 25080 AM filter cloths at 1400 L/hr recycling the product back to the feed tank for 10 minutes. The pore size of the filter cloths was sufficient to prevent passage of the filter aid. At the end of recycle, the flow was adjusted to 1300 L/hr and passed through the filter. Once the tank was empty an additional 50 liters of water was pushed into the filter. The fluid from this water flush and a 12 bar compression of the cake were both added to the collected permeate. The filter was cleaned after use.

The filtered permeate, water flush, and compression fluid was agitated and heated back to 80° C.

The heated mixture had 6 kg of Dicalite 4158 added thereto and was mixed for 10 minutes. At 1400 L/hr this solution was recycled through a clean Choquenet 12 m² press filter with Sefar Fyltris 25080 AM filter cloths at 1400 L/hr for 15 minutes. After the recycle, the tank was passed through the filter at 1400 L/hr.

Without cleaning the filter, 5.33 g/L of Clarcel® DICS (water permeability 2.4 Darcies to 4.0 Darcies) and 6.667 g/L of Clarcel® CBL (water permeability 0.049 Darcies to 0.101 Darcies) were added to the mixture and agitation was performed for one hour while maintaining the temperature at 80° C. This mixture was then recycled through the Dicalite coated Choquenet 12 m² press filter with Sefar Fyltris 25080 AM filter cloths at 1400 L/hr for 15 minutes. After the recycle, the tank was passed through the filter at 1350 L/hr. An additional 50 liters of flush water were pushed through the filter and permeate was collected as well. Compression fluid from the filter was not captured.

This twice filtered material was heated to 85° C. and left agitated without temperature control for 14 hours. At this point the material was reheated to 80° C. for a third filtration step.

The heated mixture had 6 kg of Dicalite 4158 added thereto and mixing was performed for 10 minutes. At 1400 L/hr this solution was recycled through a clean Choquenet 12 m² press filter with Sefar Fyltris 25080 AM filter cloths at 1400 L/hr for 15 minutes. After the recycle, the tank was passed through the filter at 1450 L/hr.

Without cleaning the filter, 5.33 g/L of Clarcel ® DICS and 6.667 g/L of Clarcel ® CBL were added to the mixture and agitation was performed for one hour while maintaining the temperature at 80° C. This mixture was then recycled through the Dicalite coated Choquenet 12 m² press filter with Sefar Fyltris 25080 AM filter cloths at 1600 L/hr for 15 minutes. After the recycle, the tank was passed through the filter at 1700 L/hr. An additional 50 liters of flush water was pushed through the filter and permeate was collected as well. Compression fluid from the filter was not captured.

The triple filtered permeate was cooled to 60° C. and mixed with 83% IPA at a 1:2 ratio, 2 g IPA solution for each g of scleroglucan solution. This precipitated scleroglucan fibers which can be mechanically separated from the bulk solution. In this example, a tromel separator was used to partition the precipitated fibers from the bulk liquid solution.

After recovery of the fibers they were washed with another 0.5 g 83% IPA solution for each 1 g of initial triple filtered permeate scleroglucan solution.

Wash fibers were dried in an ECI dryer with 95° C. hot water for 1 hour and 13 minutes to produce a product with 89.3% dry matter. This material was ground up and sieved to provide powder smaller in size than 250 micron. The final ground scleroglucan material was the scleroglucan tested in Part II herein.

### Part II. Surfactant Compatibility.

Sample Preparation. Scleroglucan stock solutions were prepared in the appropriate brines using the IKA® Magic Lab®. The IKA® Magic Lab® is an inline mixer using a rotor stator to impart shear on the solution. The solution was processed through Magic Lab for the number of passes indicated. As used herein, term ‘pass’ denotes feeding solution to the Magic Lab and collecting it at the discharge. One ‘pass’ means solution has been processed through the equipment one time. Each pass through the single rotor stator assembly of the Magic Lab subjected the Sample to a shear rate (s⁻¹) of about 10 times the rotor speed setting in rpm for a duration of about 0.01 s to about 1 s. The scleroglucan solutions were prepared using 6 passes through the Magic Lab at 26,000 rpm.

Scleroglucan stock solutions were used the same day they were prepared. Biocide was not included in the Scleroglucan used in this study. Modified-HPAM stock solutions were prepared in the appropriate brines using the overhead mixer for 2 hours. The modified-HPAM was an HPAM-AMPS (hydrolyzed polyacrylamide/2-acrylamino-2-methylpropane sulfonic acid) copolymer. Modified-HPAM stock solutions were stored in the refrigerator until needed. The modified-HPAM was selected for Reservoir 1 due its thermal stability at similar high temperatures in soft brine.

Brine Compositions. The compositions of the injection brines used in this study are shown in Tables 1A and 1B. For Reservoir 1, a softened high-salinity synthetic seawater (Soft Brine 1) with a TDS of about 50k ppm was used for both the ASP and SP formulations at 92° C. For Reservoir 2, a hard seawater (Hard Seawater 2) was the injection brine for the SP formulation and a softened version (Soft Seawater 2) was used for the ASP formulation injection brine.

TABLE 1A
Soft Brine 1 Composition (for Reservoir 1).
Soft Brine 1

| Ion | ppm |
|---|---|
| Ca⁺⁺ | 0 |
| Mg⁺⁺ | 0 |
| K⁺ | 551 |
| Na⁺ | 18860 |
| HCO₃⁻ | 0 |
| Cl⁻ | 26853 |
| SO₄⁻² | 3700 |
| TDS | 49964 |

TABLE 2A
Hard and Soft Seawater 2 Compositions (for Reservoir 2).

| | Hard Seawater 2 | Soft Seawater 2 |
|---|---|---|
| Ion | ppm | ppm |
| Ca⁺⁺ | 389 | 0 |
| Mg⁺⁺ | 1227 | 0 |
| K⁺ | 372 | 372 |
| Na⁺ | 10182 | 12954 |
| HCO₃⁻ | 0 | 0 |
| Cl⁻ | 18458 | 18458 |
| SO₄⁻² | 2478 | 2478 |
| TDS | 33176 | 34324 |

Reservoir 1 conditions. The reservoir temperature was 92° C. The injection brine was Soft Brine 1. The reservoir permeability was >500 mD. The API gravity (density at 15° C.) was ˜34. Dead oil (stock tank oil) viscosity was 3 cP. Live oil (reservoir oil) viscosity was ˜1 cP. Surrogate oil was Dead crude oil+15% by weight cyclohexane. The surrogate oil viscosity was 1.6 cP. Surrogate oil was used for all Reservoir 1 microemulsion experiments in this study. The oil-water inter-facial tension (IFT) at 22° C. was 28 dynes/cm. The appearance was black oil.

Reservoir 1 SP Formulation included 0.45 wt % Oleyl-45PO-20EO carboxylate (from UEORS), 0.35 wt % Enordet O332 (light IOS, internal olefin sulfonate, from Shell Chemical), and 0.2 wt % Enordet O342 (medium IOS from Shell Chemical). The injection brine was Soft Brine 1. The salinity gradient was examined via sodium chloride scan. The pH was neutral to ˜7-8. The viscosifier was 780 ppm Scleroglucan or 3500 ppm modified-HPAM polymers. The temperature was 92° C.

The Reservoir 1 ASP Formulation included 0.45 wt % Oleyl-45PO-20EO carboxylate (from UEORS), 0.35 wt % Enordet O332 (light IOS, internal olefin sulfonate, from Shell Chemical), and 0.2 wt % Enordet O342 (medium IOS from Shell Chemical). The injection brine was Soft Brine 1. Salinity gradient was examined via sodium carbonate scan. The pH was ˜10-11. The viscosifiers usere were 780 ppm Scleroglucan or 3500 ppm modified-HPAM polymers. The temperature was 92° C.

Reservoir 2 conditions. The reservoir temp was 52° C. The injection brine was Hard Seawater 2 (for SP) or Soft Seawater 2 (for ASP). The reservoir permeability was ˜10-500 mD. The API gravity (density at 15° C.) was ˜32. The dead oil viscosity was ˜2-3 cP. The live oil viscosity was ˜1.5 cP. The surrogate oil was Dead oil+15 wt % isooctane. The surrogate oil viscosity was 1.9 cP with 15% wt. isooctane. Surrogate oil was used for all Reservoir 2 microemulsion experiments in this study. The appearance was black oil.

The Reservoir 2 SP Formulation included 0.5 wt % Enordet J11111 (propoxy sulfate from Shell Chemical), 0.5 wt % Enordet O332 (light IOS, internal olefin sulfonate, from Shell Chemical), and 1.0 wt % Isobutanol-10EO (cosolvent). The injection brine was Hard Seawater 2. The salinity gradient was examined via sodium chloride scan. The pH was neutral to ˜7.5-8.5. The viscosifiers used were 520 ppm Scleroglucan or 2800 ppm modified-HPAM polymers. The temperature was 52° C.

The Reservoir 2 ASP Formulation included 0.5 wt % Enordet J11111 (propoxy sulfate from Shell Chemical), 0.5 wt % Enordet O332 (light IOS, internal olefin sulfonate, from Shell Chemical), and 1.0 wt % Isobutanol-10EO (cosolvent). The injection brine was Soft Seawater 2. Salinity gradient was examined via a sodium carbonate scan. The pH was ˜10-11. The viscosifiers used were 520 ppm Scleroglucan or 2800 ppm modified HPAM polymers. The temperature was 52° C.

### Example II-1. Polymer Rheology

The objective of the rheology study was to determine the appropriate concentration of polymer for each of the SP formulations at the estimated optimal salinity conditions. An Anton Paar MCR302 Rheometer was used for the viscosity measurements as a function of shear-rate. For Reservoir 1, the polymer concentration in Soft Brine 1+1.75% NaCl (by weight) was varied. The viscosity of each solution was measured at 3 set temperatures (30, 50, and 70° C.) and extrapolated to reservoir temperature, 92° C. The samples for Reservoir 2 used Hard Seawater 2+2.75% NaCl (by weight). The Reservoir 2 solutions were measured directly at reservoir temperature, 52° C.

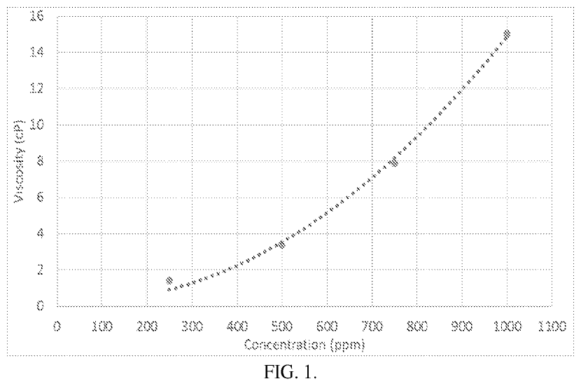

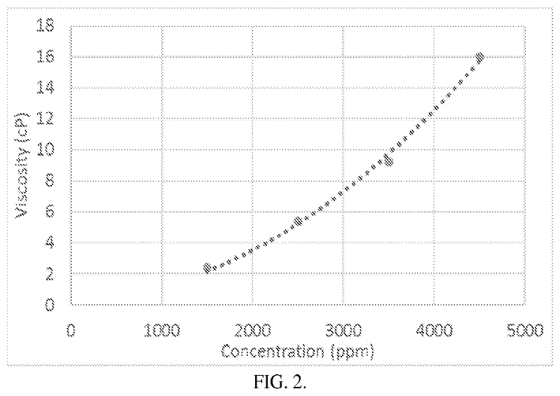

FIGS. 1 and 2 show the extrapolated viscosity versus concentration data for Scleroglucan and modified-HPAM, respectively, that were generated for Reservoir 1 at 92° C. and 7.3 s⁻¹ in Soft Brine 1+1.75%NaCl. 3500 ppm modified-HPAM and 780 ppm Scleroglucan (about 9 cP at 92° C. and 7.3 s⁻¹) were chosen for the compatibility study for Reservoir 1.

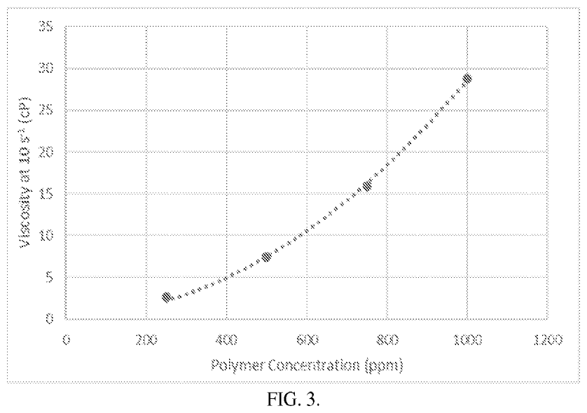

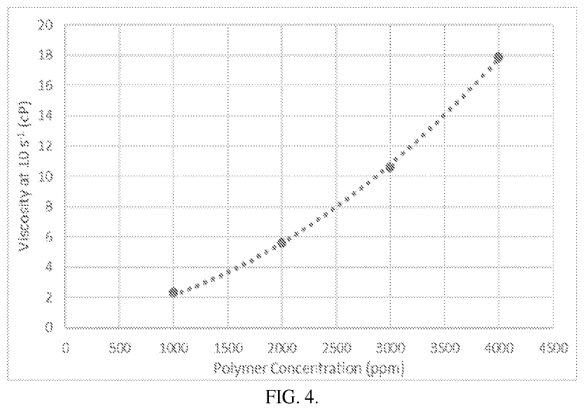

Viscosity data generated for Reservoir 2 at 52° C. is presented in FIGS. 3-4. FIG. 3 illustrates viscosity versus scleroglucan concentration in Hard Seawater 2+2.75% NaCl at 10 s⁻¹ and 52° C. FIG. 4 illustrates viscosity versus scleroglucan concentration in Hard Seawater 2+2.75% NaCl at 10 s⁻¹ and 52° C. The modified-HPAM concentration selected was 2800 ppm and the Scleroglucan concentration was 520 ppm for the surfactant compatibility study of Reservoir 2.

### Example II-2. Aqueous Stability

The aqueous stability experiments included mixing the aqueous components, including polymer, injection brine, the surfactant formulation, and additional salt or alkali for the salinity scan, in a borosilicate glass ampule. For SP formulations, sodium chloride was used in order to determine the maximum tolerated concentration of salt. Stock solutions of the components (typically 2-8×) were mixed until homogeneous. The stock solutions were added to 20-mL borosilicate glass ampules (from Wheaton) volumetrically using an Eppendorf Repeater Pipette Dispenser and appropriate tips. The aqueous stability limit is the highest salinity with a clear solution (no phase separation or haziness). Similarly, sodium carbonate was used for the ASP formulation aqueous stability experiments. Argon was used to purge the head-space above the solutions before the ampules were sealed using an oxygen-propane torch to prevent evaporation to prevent and remove oxygen. The solutions were no degassed before they were added to the ampules, so they contained dissolved oxygen. The ampules were mixed well (using a vortex mixer) until homogeneous and observed visually at room temperature. The solutions were then equilibrated at reservoir temperature and visually observed for clarity, color, phase separation of the surfactant or polymer, precipitation, or other changes to the solutions. Scleroglucan, modified-HPAM, and a control without polymer were examined.

The results of the aqueous stability testing for Reservoir 1 at 92° C. are listed in Table 2. Soft Brine 1 was the base brine with sodium chloride added for the salinity scan for SP. The SP formulation with both polymers (Scleroglucan and modified-HPAM) showed a gradual decrease in the aqueous stability with time. The SP Formulation without polymer had an aqueous stability limit of 72 k ppm TDS. The polymer-free case did not change over time indicating the surfactant formulation was stable. The aerobic conditions of the solutions (which were not degassed) are suspected of causing degradation of the polymers resulting in a gradual decrease of the aqueous stability. Both polymers are known to degrade at high temperature in the presence of oxygen, however under anaerobic conditions the polymers are stable.

TABLE 2
Aqueous Stability Results for Reservoir 1 Samples at 92° C.

| | | Temp | | | Aq. Stability | Age | |
|---|---|---|---|---|---|---|---|
| Exp. | Reservoir | (° C.) | Polymer | | Limit (TDS) | (days) | Notes |
| SP Form. | 1 | 92 | None | | 72k ppm | 14-29 | |
| SP Form. | 1 | 92 | 780 | ppm | All clear | 1 | Aerobic conditions |
| | | | Scleroglucan | | (>96k ppm) | | |
| | | | | | 86k ppm | 2 | |
| | | | | | 81k ppm | 3 | |
| | | | | | 61k ppm | 7 | |
| | | | | | 51k ppm | 10 | |
| | | | | | ≤46k | 14-28 | |
| SP Form | 1 | 92 | 3500 | ppm | 92k ppm | 1-5 | Anaerobic conditions |
| | | | modified HPAM | | | | |
| SP Form. | 1 | 92 | 3500 | ppm | All clear | 1 | Aerobic conditions |
| | | | modified-HPAM | | (>96k ppm) | | |
| | | | | | 91k ppm | 2 | |
| | | | | | 86k ppm | 3 | |
| | | | | | 66k ppm | 7 | |
| | | | | | 61k ppm | 10-14 | |
| | | | | | 51k ppm | 22-28 | |
| ASP Form. | 1 | 92 | None | | All clear | 1-28 | Etching of glass |
| | | | | | (>96k ppm) | | |
| ASP Form. | 1 | 92 | 3500 | ppm | All clear | 1-28 | Etching of glass |
| | | | modified-HPAM | | (>96k ppm) | | |
| ASP Form. | 1 | 92 | 780 | ppm | Surfactants | 1-28 | Polymer separated out into |

| | | |
|---|---|---|
| Scleroglucan | soluble >96k | compact cylinder. Etching of |
| | ppm | borosilicate glass. |

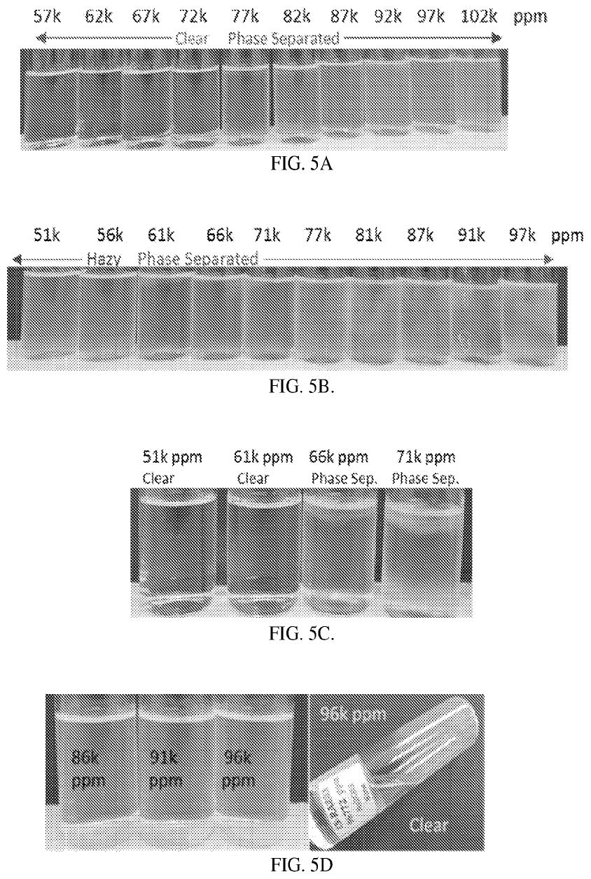

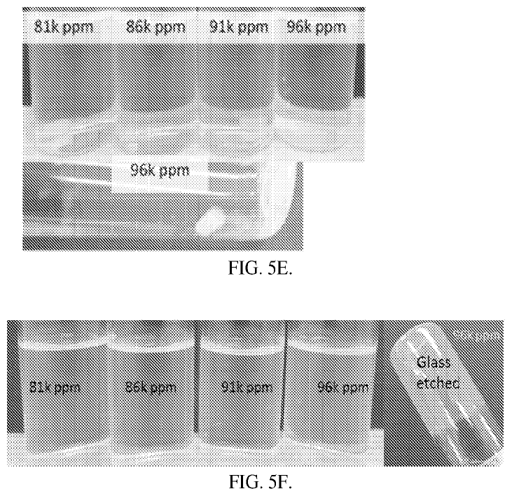

Photos of the aqueous stability experiments for Reservoir 1 at 92° C. are shown in FIGS. 5A-F. FIG. 5A illustrates aqueous stability of SP Formulation for Reservoir 1 with no polymer after 3.5 weeks. FIG. 5B illustrates aqueous stability of SP Formulation for Reservoir 1 with 780 ppm Scleroglucan after 2 weeks. FIG. 5C illustrates aqueous stability of SP Formulation for Reservoir 1 with 3500 ppm modified-HPAM after 2 weeks. FIG. 5D illustrates aqueous stability of ASP Formulation for Reservoir 1 with no polymer after 2 weeks (left). Haziness is from etched glass, solutions are clear (right). FIG. 5E illustrates aqueous stability of ASP Formulation for Reservoir 1 with 780 ppm Scleroglucan after 2 weeks (top). Haziness is from etched glass, solutions are clear (bottom). White cylinder in photos (larger in bottom photo) is precipitated Scleroglucan. FIG. 5F illustrates aqueous stability of ASP Formulation for Reservoir 1 with 3500 ppm modified-HPAM after 2 weeks (left). Haziness is from etched glass, solutions are clear (right).

The ASP Formulation aqueous stability limits for Reservoir 1 are also included in Table 2. The base injection brine was also Soft Brine 1 and sodium carbonate was used for the salinity gradient. The ASP solutions for modified-HPAM, polymer-free, and scleroglucan cases remained clear without surfactant phase separation. However, the scleroglucan was visible as a small, white, compact cylinder precipitate in the ASP Formulation samples (see FIG. 5E). The reaction of the alkali with the borosilicate glass of the ampules may have interacted with the polymer and possibly caused cross-linking. There is evidence of the high pH solutions etching the glass ampules (see the FIGS. 5D-F), which would increase amount of boron and silica in solution. The precipitation did not occur with the synthetic polymer, despite etching of the glass.

The Reservoir 2 results, at 52° C., are in Table 3. The base injection brine for the SP samples was Hard Seawater 2. The SP Formulation for Reservoir 2 aqueous stability results were higher without polymer (at 75 k ppm TDS) than with either of the polymers (60 k ppm TDS for both modified-HPAM and scleroglucan).

TABLE 3
Aqueous Stability Results for Reservoir 2 Samples at 52° C.

| | | | | Aq. | |
|---|---|---|---|---|---|
| | | | | Stability | |
| | | Temp | | Limit | |
| Exp. | Reservoir | (° C.) | Polymer | (TDS) | Notes |
| SP Form | 2 | 52 | None | 70 k ppm | |
| SP Form | 2 | 52 | 520 ppm | 60 k ppm | |
| | | | Scleroglucan | | |
| SP Form | 2 | 52 | 2800 ppm | 60 k ppm | |
| | | | modified-HPAM | | |
| ASP Form | 2 | 52 | None | 90 k ppm | |
| ASP Form | 2 | 52 | 520 ppm | 90 k ppm | Separation of some polymer, with |
| | | | Scleroglucan | | surfactants remaining in solution |
| ASP Form | 2 | 52 | 2800 ppm | 90 k ppm | |
| | | | modified-HPAM | | |

The ASP Formulation aqueous stability used Soft Seawater 2 as the injection brine with sodium carbonate for the salinity gradient. The results were not time dependent. The surfactant phase separation occurred at the same salinity in all 3 cases. Although the same surfactants were used in the SP and ASP formulations for Reservoir 2, the aqueous stability results were different. The differences in performance may be due to the pH and the presence of divalent cations in the hard brine of the SP experiments. The pH and divalent cations affect the molecular interactions of the surfactants.

Although surfactant phase separation occurred at the same salinity for the scleroglucan as the other cases, precipitation was observed. A small amount of clear gel-like or film-like material was observed in the Scleroglucan samples. No precipitate was observed in the polymer-free or modified-HPAM samples. It is possible that the dissolution of the borosilicate glass at high pH impacted the scleroglucan, however in this case (possibly due to the lower temperature) the precipitate was smaller.

### Example II-3. Microemulsion Phase Behavior

Phase behavior experiments were conducted in which the (surrogate) oil was mixed with an aqueous solution consisting of the injection brine and the chemical formulation (surfactant(s), cosolvent, and sometimes polymer) in a salinity scan. Salinity scans were produced by varying the amount of sodium chloride (for SP) or sodium carbonate (for ASP) or by varying the ratio of 2 brines with different salinities (e.g., produced brine and seawater). Concentrated stock solutions (typically 2-8×) of each component were prepared and mixed until homogenous. The stock solutions and brine were added volumetrically to a 5-ml borosilicate glass pipette (with a sealed bottom) with an Eppendorf Repeater Pipette Dispenser. After sufficient time for the aqueous solutions (especially polymer) to settle to the bottom of the pipettes, the aqueous interface levels were measured using the graduated markings on the pipettes. The oil was added to the pipette last.

The pipettes were purged with argon to replace oxygen from the headspace of the samples (note, the typical procedure does not remove all the oxygen as the solutions are not de-gassed). To prevent evaporation, the samples were sealed inside the 5-mL glass pipettes using an oxygen-propane torch. The pipettes were mixed well for several days and equilibrated at reservoir temperature. The pipettes were initially observed visually as they equilibrated. Qualitative observations of IFT were determined using the emulsion (tilt) test to observe the mixing behavior of the phases. Quantitative measurement of the IFT and solubilization ratio (using the volume of each phase) were conducted after the samples have equilibrated at reservoir temperature.

The solubilization ratio (σ) was measured quantitatively via changes of the interface levels after a microemulsion was formed. The solubilization ratio of oil (σₒ) is the volume of oil solubilized in the microemulsion (vₒ) divided by the volume of surfactant in the microemulsion (vₛ) which is assumed to be all the surfactant in the sample. Similarly, the solubilization of water (σ_{w}) is the volume of water solubilized in the microemulsion (v_{w}) divided by the volume of surfactant (vₛ). Once the microemulsion was equilibrated, the solubilization ratio is related to the interfacial tension (γ) by the Chun Huh equation,

$${γ}_{o} = \frac{C}{{σ}_{o}^{2}}$$

$${γ}_{w} = \frac{C}{{σ}_{w}^{2}}$$

$${σ}_{o} = \frac{{V}_{o}}{Vs}$$

$${σ}_{w} = \frac{{V}_{w}}{Vs}$$

where γₒ is the interfacial tension of the oil-microemulsion, γ_{w} is the interfacial tension of the water-microemulsion, and C is a constant that is equal to about 0.3.

At the optimal salinity, γₒ=γ_{w}. Based on the Chun Huh equation, a solubilization ratio of at least 10 is required to obtain an interfacial tension on the order of 10⁻³ dynes/cm, which is a reasonable interfacial tension for chemical EOR. In addition, the formulation should have a reasonable optimum salinity for the salinity gradient of the flood, reasonable alkali concentration (for ASP), a low IFT (assessed visually), an acceptably low microemulsion viscosity, minimal formation of viscous phases (macroemulsions), a relatively-fast equilibration time, aqueous stability at the planned injection slug salinity, and robustness (width of the low IFT region). Each phase behavior experiment is assessed for these criteria.

### Microemulsion Phase Behavior for Reservoir 1.

Microemulsion phase behavior experiments were conducted with Oil 1 at 92° C. with Scleroglucan, modified-HPAM, and without polymer (the control) in order to determine the impact of the polymer on the microemulsion properties such as solubilization ratio, interfacial tension, and optimal salinity.

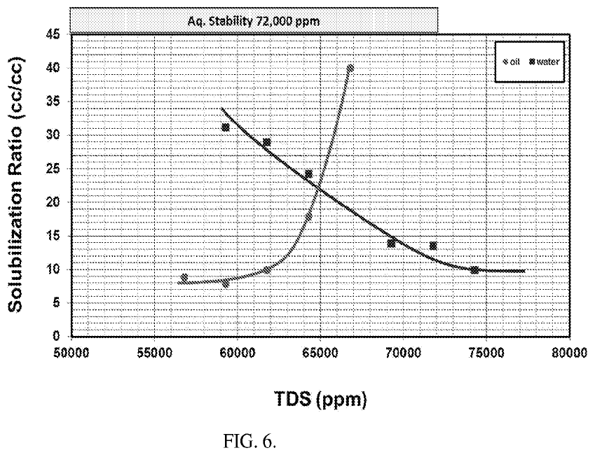

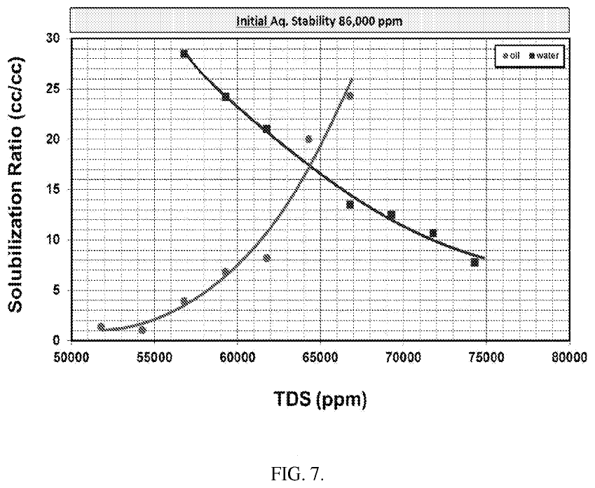

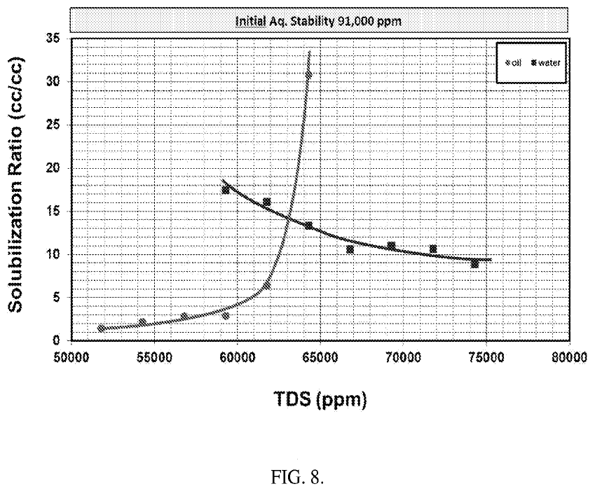

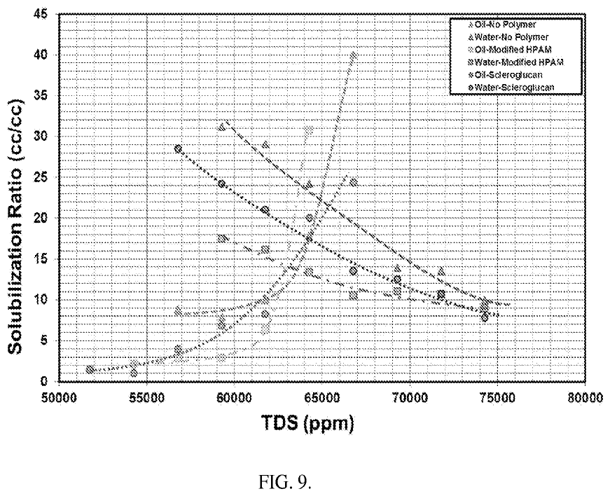

FIG. 6 illustrates solubilization versus TDS for Reservoir 1 SP Formulation without polymer at 92° C. FIG. 7 illustrates solubilization versus TDS for Reservoir 1 SP Formulation with 780 ppm Scleroglucan at 92° C. FIG. 8 illustrates solubilization versus TDS for Reservoir 1 SP Formulation with 3500 ppm modified-HPAM at 92° C. FIG. 9 illustrates solubilization versus TDS for Reservoir 1 SP Formulations with polymer-free, 780 ppm Scleroglucan, and 3500 ppm modified-HPAM at 92° C. A solubilization ratio of 10 or more indicates an ultra-low interfacial tension that is sufficient for surfactant flooding. The optimal salinity is the salinity where the water and oil solubilization ratio curves cross. For the SP formulation, the optimal salinity was 63-65 k ppm TDS for all 3 cases after equilibration at reservoir temperature for 22-30 days. An optimal salinity shift of 2-3 k ppm TDS is within the error of the measurements and is insignificant. A shift of this magnitude would not have an impact on the performance of the formulation in the field. A salinity gradient is incorporated into a surfactant flood design that would sweep over a wide range of salinities (much more than 5 k ppm TDS).

After equilibration, the solubilization ratio at optimum was highest for the polymer-free (control) case at 22, with 17 for Scleroglucan, and 14 for the modified-HPAM. The change in the optimum solubilization ratio can be observed on this plot for the 3 cases. The modified-HPAM has a significantly lower optimal solubilization ratio compared to the other experiments, which signifies a higher IFT (interfacial tension). The higher concentration of modified-HPAM that is required to reach the target viscosity under these conditions may be contributing to the increase in IFT. However, the optimal solubilization ratio of the modified-HPAM is still 10 or above, therefore it is still in the ultra-low IFT range and generally would be acceptable for flooding. All else being equal, the polymer that has the higher solubilization ratio (lower IFT) is generally the better performing. The negative impact on the IFT from adding polymer to the Reservoir 1 SP formulation is less for Scleroglucan than for the modified-HPAM.

The range of ultra-low IFT, is the salinity range where the solubilization ratios are 10 or higher. This salinity range occurs near the optimum and a larger range of ultra-low IFT is generally better for surfactant-flooding. In this case, the ultra-low IFT range is around 10 k ppm TDS for all 3 SP formulation cases indicating a good robustness.

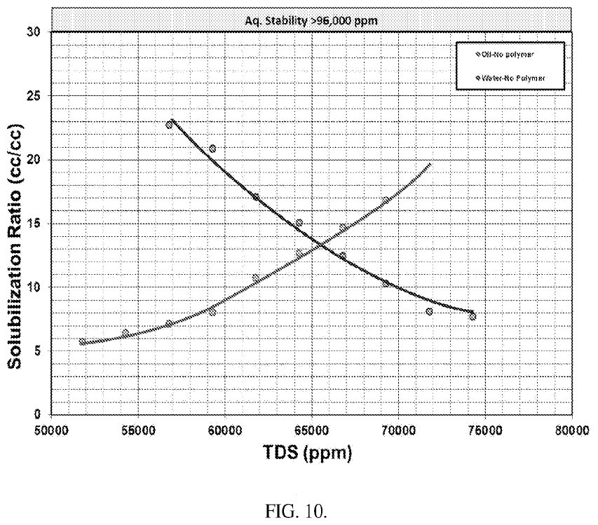

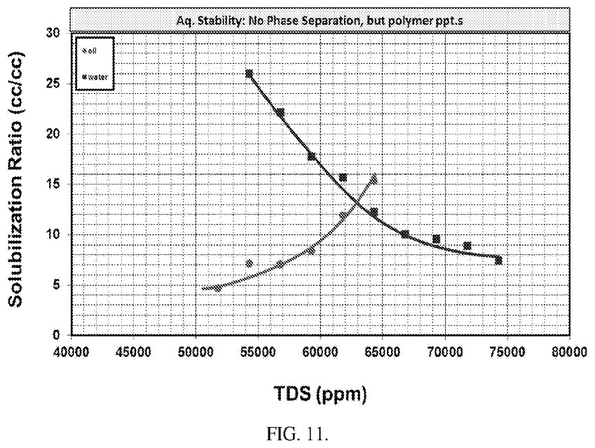

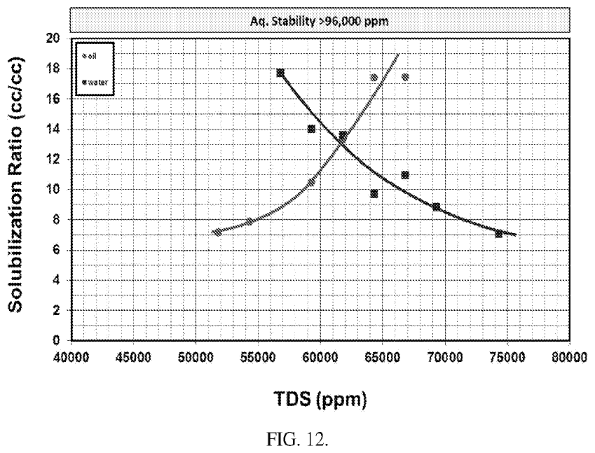

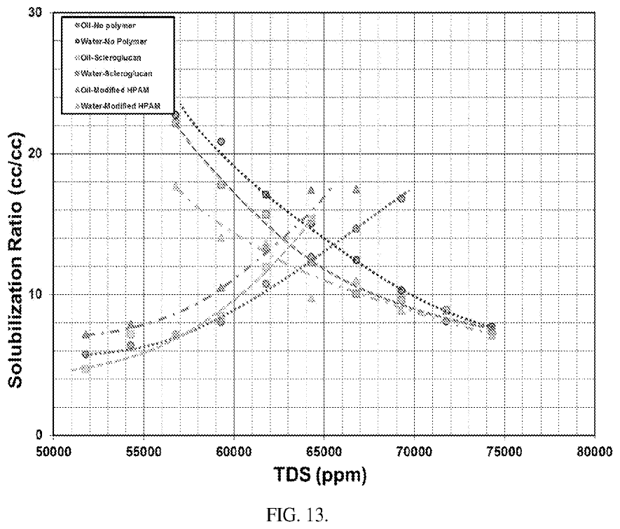

FIG. 10 illustrates solubilization versus TDS for Reservoir 1 ASP Formulation without Polymer at 92° C. FIG. 11 illustrates solubilization versus TDS for Reservoir 1 ASP Formulation with 780 ppm Scleroglucan at 92° C. FIG. 12 illustrates solubilization versus TDS for Reservoir 1 ASP Formulation with 3500 ppm modified-HPAM at 92° C. FIG. 13 illustrates solubilization versus TDS for Reservoir 1 ASP Formulations with No Polymer, 780 ppm Scleroglucan, and 3500 ppm modified-HPAM at 92° C.

The optimal solubilization ratios are approximately 13 for all 3 ASP series. Unlike the SP formulation, the ASP formulations were unaffected by the addition of polymer, even the 3500-ppm modified-HPAM had no measurable effect on the IFT. In addition, the ultra-low IFT range (robustness) is very similar for all 3 cases (about 10 k ppm). The robustness of the SP and ASP formulations were about the same for Reservoir 1. No surfactant phase separation was observed.

The microemulsion phase behavior experiments with Scleroglucan in SP and ASP formulations show no impact on the optimum salinity or robustness of the formulations, indicating excellent compatibility. The scleroglucan reduced the SP formulation optimum solubilization ratio to a lesser degree than the modified-HPAM. The optimum solubilization ratio remained constant for the ASP formulation.

### Microemulsion Phase Behavior for Reservoir 2.

Microemulsion phase behavior experiments were conducted with (surrogate) Oil 2 at 52° C. with Scleroglucan, modified-HPAM, and without polymer in order to determine any changes in the microemulsion properties such as solubilization ratio, interfacial tension, and optimal salinity.

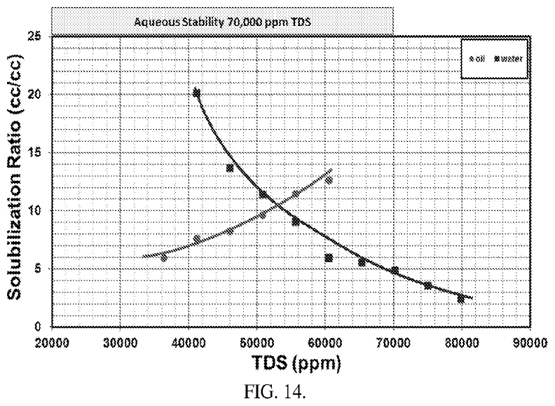

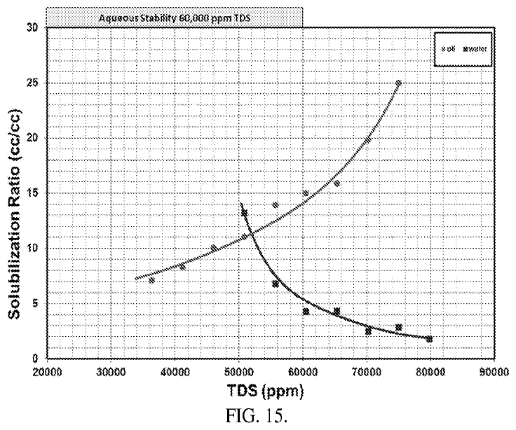

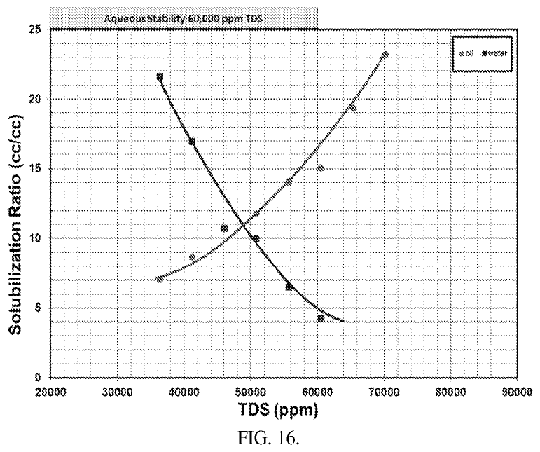

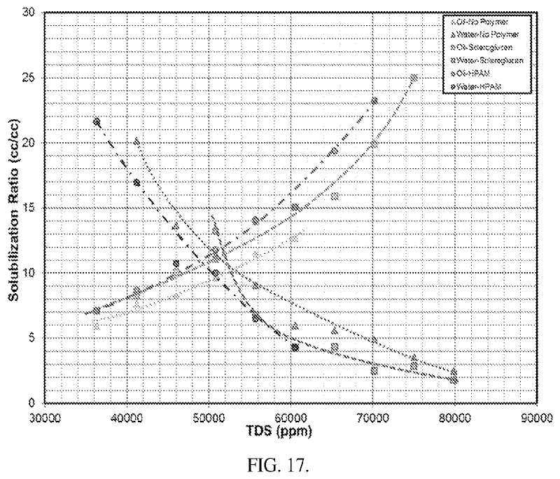

FIG. 14 illustrates Reservoir 2 SP Formulation with No Polymer at 52° C. FIG. 15 illustrates solubilization versus TDS for Reservoir 2 SP Formulation with 520 ppm Scleroglucan at 52° C. FIG. 16 illustrates solubilization versus TDS for Reservoir 2 SP Formulation with 2800 ppm modified-HPAM at 52° C. FIG. 17 illustrates solubilization versus TDS for Reservoir 2 SP Formulations with No Polymer, 520 ppm scleroglucan, and 2800 ppm modified-HPAM at 52° C.

The optimal salinity for the scleroglucan study was about the same as that for the control, however, the optimal salinity of the modified-HPAM scan was slightly lower (about 4 k ppm TDS) than that of the control. Although the modified-HPAM affected the optimal salinity more than the Scleroglucan, the shift in optimal salinity would not have an impact on the performance of the formulation in the field due to the salinity gradient that is applied during the flood.

The solubilization ratio at the optimal salinity was not affected by the presence of either polymer and remained at about 11. The addition of both polymers to the SP Formulation caused a decrease in the aqueous stability from 75 k to 60 k ppm TDS. Despite the lower aqueous stability limits, the SP formulations with scleroglucan and modified-HPAM are suitable for surfactant flooding since the aqueous stability remains higher than the optimal salinity. At high temperature in Reservoir 1, the aqueous stability initially was higher with the polymer than with the control, the opposite of the trend observed here. For the control (polymer-free) case, the solubilization ratio plot shows ultra-low IFT from 52-54 k ppm TDS. For the scleroglucan study, the plot showed 47-53 k ppm TDS had ultra-low IFT. Similarly, the modified-HPAM scan had ultra-low IFT from 47-50 k ppm.

The Reservoir 2 phase behavior establishes that the scleroglucan did not affect the interfacial tension or the optimal salinity when added to the SP formulation in hard brine. The aqueous stability of the SP formulation decreased with the addition of either polymer, but it remained above the optimal salinity. The modified-HPAM decreased both the optimum salinity and the aqueous stability, indicating that the SP formulation was less hydrophilic when the modified-HPAM was added. However, the modified-HPAM also did not change the IFT.

The terms and expressions that have been employed are used as terms of description and not of limitation, and there is no intention in the use of such terms and expressions of excluding any equivalents of the features shown and described or portions thereof, but it is recognized that various modifications are possible within the scope of the present invention. Thus, it should be understood that although the present invention has been specifically disclosed by specific aspects and optional features, modification and variation of the concepts herein disclosed may be resorted to by those of ordinary skill in the art, and that such modifications and variations are considered to be within the scope of the present invention.

### Exemplary Aspects.

The following exemplary aspects are provided, the numbering of which is not to be construed as designating levels of importance:

Aspect 1 provides an aqueous beta-glucan composition comprising:
a beta-glucan; and
a surfactant.

Aspect 2 provides the composition of Aspect 1, wherein a 780 ppm mixture of the beta-glucan in a salt water having a total dissolved solids level of about 67,500 ppm at 92° C. and 7.3 s⁻¹ has a viscosity of about 9 cP.

Aspect 3 provides the composition of any one of Aspects 1-2, wherein a 520 ppm mixture of the beta-glucan in a salt water having a total dissolved solids level of 33,100 ppm at 52° C. and 10 s⁻¹ has a viscosity of about 8 cP.

Aspect 4 provides the composition of any one of Aspects 1-3, wherein the composition has a pH of about 2 to about 11.

Aspect 5 provides the composition of any one of Aspects 1-4, wherein the composition has a pH of about 7 to about 8.5.

Aspect 6 provides the composition of any one of Aspects 1-5, wherein the composition has a pH of about 10 to about 11.

Aspect 7 provides the composition of any one of Aspects 1-6, wherein the aqueous beta-glucan composition is a salt water composition, wherein at a concentration of the beta-glucan of about 780 ppm and at 92° C. for at least about 14 days the composition is substantially free of phase separation and haziness according to visual detection for a total dissolved solids level up to about 30,000 ppm to about 300,000 ppm.

Aspect 8 provides the composition of any one of Aspects 1-7, wherein the aqueous beta-glucan composition is a salt water composition, wherein at a concentration of the beta-glucan of about 780 ppm and at 92° C. for at least about 14 days the composition is substantially free of phase separation and haziness according to visual detection for a total dissolved solids level up to about 46,000 ppm to about 200,000 ppm.

Aspect 9 provides the composition of any one of Aspects 5-8, wherein the aqueous beta-glucan composition is a salt water composition, wherein at a concentration of the beta-glucan of about 780 ppm and at 92° C. for at least about 14 days the composition is substantially free of phase separation and haziness according to visual detection for a total dissolved solids level up to about 30,000 ppm to about 60,000 ppm.

Aspect 10 provides the composition of any one of Aspects 5-9, wherein the aqueous beta-glucan composition is a salt water composition, wherein at a concentration of the beta-glucan of about 780 ppm and at 92° C. for at least about 14 days the composition is substantially free of phase separation and haziness according to visual detection for a total dissolved solids level up to about 46,000 ppm.

Aspect 11 provides the composition of any one of Aspects 6-10, wherein the aqueous beta-glucan composition is a salt water composition, wherein at a concentration of the beta-glucan of about 780 ppm and at 92° C. for at least about 14 days the composition is substantially free of phase separation and haziness according to visual detection for a total dissolved solids level up to about 50,000 ppm to about 300,000 ppm or more.

Aspect 12 provides the composition of any one of Aspects 6-11, wherein the aqueous beta-glucan composition is a salt water composition, wherein at a concentration of the beta-glucan of about 780 ppm and at 92° C. for at least about 14 days the composition is substantially free of phase separation and haziness according to visual detection for a total dissolved solids level up to about 96,000 ppm to about 200,000 ppm.

Aspect 13 provides the composition of any one of Aspects 1-12, wherein the aqueous beta-glucan composition is a salt water composition, wherein at a concentration of the beta-glucan of about 520 ppm and at 52° C. for at least about 14 days the composition is substantially free of phase separation and haziness according to visual detection for a total dissolved solids level up to about 40,000 ppm to about 110,000 ppm.

Aspect 14 provides the composition of any one of Aspects 1-13, wherein the aqueous beta-glucan composition is a salt water composition, wherein at a concentration of the beta-glucan of about 520 ppm and at 52° C. for at least about 14 days the composition is substantially free of phase separation and haziness according to visual detection for a total dissolved solids level up to about 60,000 ppm to about 90,000 ppm.

Aspect 15 provides the composition of any one of Aspects 5-14, wherein the aqueous beta-glucan composition is a salt water composition, wherein at a concentration of the beta-glucan of about 520 ppm and at 52° C. for at least about 14 days the composition is substantially free of phase separation and haziness according to visual detection for a total dissolved solids level up to about 40,000 ppm to about 80,000 ppm

Aspect 16 provides the composition of any one of Aspects 5-15, wherein the aqueous beta-glucan composition is a salt water composition, wherein at a concentration of the beta-glucan of about 520 ppm and at 52° C. for at least about 14 days the composition is substantially free of phase separation and haziness according to visual detection for a total dissolved solids level up to about 60,000 ppm.

Aspect 17 provides the composition of any one of Aspects 6-16, wherein the aqueous beta-glucan composition is a salt water composition, wherein at a concentration of the beta-glucan of about 520 ppm and at 52° C. for at least about 14 days the composition is substantially free of phase separation and haziness according to visual detection for a total dissolved solids level up to about 70,000 ppm to about 110,000 ppm.

Aspect 18 provides the composition of any one of Aspects 6-17, wherein the aqueous beta-glucan composition is a salt water composition, wherein at a concentration of the beta-glucan of about 520 ppm and at 52° C. for at least about 14 days the composition is substantially free of phase separation and haziness according to visual detection for a total dissolved solids level up to about 90,000 ppm.

Aspect 19 provides the composition of any one of Aspects 1-18, wherein the aqueous beta-glucan composition is a salt water composition, wherein at a concentration of the beta-glucan of about 780 ppm and at 92° C. and in an emulsion with crude oil the composition has an oil solubilization ratio that is equal to a water solubilization ratio of the composition at a total dissolved solids level of about 55,000 ppm to about 75,000 ppm.

Aspect 20 provides the composition of any one of Aspects 1-19, wherein the aqueous beta-glucan composition is a salt water composition, wherein at a concentration of the beta-glucan of about 780 ppm and at 92° C. and in an emulsion with crude oil the composition has an oil solubilization ratio that is equal to a water solubilization ratio of the composition at a total dissolved solids level of about 63,000 ppm to about 65,000 ppm.

Aspect 21 provides the composition of any one of Aspects 1-20, wherein the aqueous beta-glucan composition is a salt water composition, wherein at a concentration of the beta-glucan of about 780 ppm and at 92° C. and in an emulsion with crude oil the composition has an oil solubilization ratio of 10 or more, or a water solubilization water of 10 or more, or both, at a total dissolved solids level of about 61,000 ppm to about 71,000 ppm.

Aspect 22 provides the composition of any one of Aspects 5-21, wherein the aqueous beta-glucan composition is a salt water composition, wherein at a concentration of the beta-glucan of about 780 ppm and at 92° C. and in an emulsion with crude oil the composition has an oil solubilization ratio that is equal to a water solubilization ratio of the composition at a total dissolved solids level of about 60,000 ppm to about 70,000 ppm.

Aspect 23 provides the composition of any one of Aspects 5-22, wherein the aqueous beta-glucan composition is a salt water composition, wherein at a concentration of the beta-glucan of about 780 ppm and at 92° C. and in an emulsion with crude oil the composition has an oil solubilization ratio that is equal to a water solubilization ratio of the composition at a total dissolved solids level of about 64,000 ppm to about 65,000 ppm.

Aspect 24 provides the composition of any one of Aspects 5-23, wherein the aqueous beta-glucan composition is a salt water composition, wherein at a concentration of the beta-glucan of about 780 ppm and at 92° C. and in an emulsion with crude oil the composition has an oil solubilization ratio of 10 or more, or a water solubilization water of 10 or more, or both, at a total dissolved solids level of about 62,000 ppm to about 71,000 ppm.

Aspect 25 provides the composition of any one of Aspects 6-24, wherein the aqueous beta-glucan composition is a salt water composition, wherein at a concentration of the beta-glucan of about 780 ppm and at 92° C. and in an emulsion with crude oil the composition has an oil solubilization ratio that is equal to a water solubilization ratio of the composition at a total dissolved solids level of about 60,000 ppm to about 70,000 ppm

Aspect 26 provides the composition of any one of Aspects 6-25, wherein the aqueous beta-glucan composition is a salt water composition, wherein at a concentration of the beta-glucan of about 780 ppm and at 92° C. and in an emulsion with crude oil the composition has an oil solubilization ratio that is equal to a water solubilization ratio of the composition at a total dissolved solids level of about 63,000 ppm.

Aspect 27 provides the composition of any one of Aspects 6-26, wherein the aqueous beta-glucan composition is a salt water composition, wherein at a concentration of the beta-glucan of about 780 ppm and at 92° C. and in an emulsion with crude oil the composition has an oil solubilization ratio of 10 or more, or a water solubilization water of 10 or more, or both, at a total dissolved solids level of about 61,000 ppm to about 66,000 ppm.

Aspect 28 provides the composition of any one of Aspects 1-27, wherein the aqueous beta-glucan composition is a salt water composition, wherein at a concentration of the beta-glucan of about 520 ppm and at 52° C. and in an emulsion with crude oil the composition has an oil solubilization ratio that is equal to a water solubilization ratio of the composition at a total dissolved solids level of about 40,000 ppm to about 55,000 ppm.

Aspect 29 provides the composition of any one of Aspects 1-28, wherein the aqueous beta-glucan composition is a salt water composition, wherein at a concentration of the beta-glucan of about 520 ppm and at 52° C. and in an emulsion with crude oil the composition has an oil solubilization ratio that is equal to a water solubilization ratio of the composition at a total dissolved solids level of about 46,000 ppm to about 48,000 ppm.

Aspect 30 provides the composition of any one of Aspects 1-29, wherein the aqueous beta-glucan composition is a salt water composition, wherein at a concentration of the beta-glucan of about 520 ppm and at 52° C. and in an emulsion with crude oil the composition has an oil solubilization ratio of 10 or more, or a water solubilization water of 10 or more, or both, at a total dissolved solids level of about 46,000 ppm to about 48,000 ppm.

Aspect 31 provides the composition of any one of Aspects 1-30, wherein water is about 70 wt % to about 99.9 wt % of the composition.

Aspect 32 provides the composition of any one of Aspects 1-31, wherein water is about 97 wt % to about 99 wt % of the composition.

Aspect 33 provides the composition of any one of Aspects 1-32, wherein water in the composition is fresh water, salt water, brine, produced water, flowback water, brackish water, sea water, synthetic sea water, or a combination thereof.

Aspect 34 provides the composition of any one of Aspects 1-33, further comprising an organic solvent.

Aspect 35 provides the composition of any one of Aspects 1-34, wherein the organic solvent is about 0.001 wt % to about 10 wt % of the composition.

Aspect 36 provides the composition of any one of Aspects 1-35, wherein the organic solvent is about 0.5 wt % to about 1.5 wt % of the composition.

Aspect 37 provides the composition of any one of Aspects 1-36, wherein the composition has a total dissolved solids level of about 0 to about 300,000 ppm.

Aspect 38 provides the composition of any one of Aspects 1-37, wherein the composition has a total dissolved solids level of about 40,000 ppm to about 200,000 ppm.

Aspect 39 provides the composition of any one of Aspects 1-38, wherein the composition has a total dissolved solids level of about 46,000 ppm to about 71,000 ppm.

Aspect 40 provides the composition of any one of Aspects 1-39, wherein the beta-glucan is substantially homogeneously distributed in the composition.

Aspect 41 provides the composition of any one of Aspects 1-40, wherein the beta-glucan is about 0.001 wt % to about 5 wt % of the composition.

Aspect 42 provides the composition of any one of Aspects 1-41, wherein the beta-glucan is about 0.04 wt % to about 0.08 wt % of the composition.

Aspect 43 provides the refined beta-glucan of any one of Aspects 1-42, wherein the beta-glucan is a 1,3 beta-glucan.

Aspect 44 provides the refined beta-glucan of any one of Aspects 1-43, wherein the beta-glucan is a 1,3-1,6 beta-D-glucan.

Aspect 45 provides the refined beta-glucan of any one of Aspects 1-44, wherein the beta-glucan is a 1,3-1,4 beta-D-glucan.

Aspect 46 provides the refined beta-glucan of any one of Aspects 1-45, wherein the beta-glucan is scleroglucan.

Aspect 47 provides the refined beta-glucan of any one of Aspects 1-46, wherein the beta-glucan is schizophyllan.

Aspect 48 provides the composition of any one of Aspects 1-47, wherein the surfactant is about 0.01 wt % to about 5 wt % of the composition.

Aspect 49 provides the composition of any one of Aspects 1-48, wherein the surfactant is about 0.5 wt % to about 1.5 wt % of the composition.

Aspect 50 provides the composition of any one of Aspects 1-49, wherein the surfactant is one or more surfactants chosen from an anionic surfactant, a cationic surfactant, or a nonionic surfactant, or a combination thereof.

Aspect 51 provides the composition of any one of Aspects 1-50, wherein the surfactant is an (C₅-C₅₀)hydrocarbyl-poly((C₂-C₃)alkylene oxide) carboxylate.

Aspect 52 provides the composition of any one of Aspects 1-51, wherein the surfactant is oleyl-45PO-20EO carboxylate.

Aspect 53 provides the composition of any one of Aspects 1-52, wherein the surfactant is an internal olefin sulfonate.

Aspect 54 provides an aqueous beta-glucan composition comprising:
a beta-glucan that is about 0.001 wt % to about 5 wt % of the composition;
one or more surfactants comprising an anionic surfactant that together are about 0.01 wt % to about 5 wt % of the composition; and
salt water that is about 88 wt % to about 99 wt % of the composition;
wherein
   the composition has a total dissolved solids level about 40,000 ppm to about 200,000 ppm,
   at a temperature of at least one of 52° C. and 92° C., the composition is substantially free of phase separation and haziness according to visual detection for at least about 14 days, and
   at a temperature of at least one of 52° C. and 92° C., and in an emulsion with crude oil, the composition has an oil solubilization ratio of 10 or more, or a water solubilization water of 10 or more, or both.

Aspect 55 provides an aqueous beta-glucan composition comprising:
scleroglucan that is about 0.04 wt % to about 0.08 wt % of the composition;
one or more surfactants comprising an anionic surfactant that together are about 0.5 wt % to about 3 wt % of the composition; and
salt water that is about 97 wt % to about 99 wt % of the composition;
wherein
   the composition has a pH of about 7 to about 8.5,
   the composition has a total dissolved solids level of about 46,000 ppm to about 71,000 ppm, and
   at a temperature of at least one of 52° C. and 92° C., and in an emulsion with crude oil, the composition has an oil solubilization ratio of 10 or more, or a water solubilization water of 10 or more, or both.

Aspect 56 provides an aqueous beta-glucan composition comprising:
scleroglucan that is about 0.04 wt % to about 0.08 wt % of the composition;
one or more surfactants comprising an anionic surfactant that together are about 0.5 wt % to about 3 wt % of the composition; and
salt water that is about 97 wt % to about 99 wt % of the composition;
wherein
   the composition has a pH of about 10 to about 11,
   the composition has a total dissolved solids level of about 61,000 ppm to about 66,000 ppm, and
   at 92° C. and in an emulsion with crude oil the composition has an oil solubilization ratio of 10 or more, or a water solubilization water of 10 or more, or both.

Aspect 57 provides a method of treating a subterranean formation, the method comprising:
placing the aqueous beta-glucan composition of any one of Aspects 1-56 in the subterranean formation.

Aspect 58 provides the method of Aspect 57, comprising performing a hydraulic fracturing operating in the subterranean formation using a liquid comprising the aqueous beta-glucan composition.

Aspect 59 provides the method of any one of Aspects 57-58, comprising performing an enhanced oil recovery procedure in the subterranean formation using a liquid comprising the aqueous beta-glucan composition.

Aspect 60 provides the method of Aspect 59, wherein the enhanced oil recovery procedure comprises polymer flooding.

Aspect 61 provides the method of any one of Aspects 59-60, wherein the liquid comprising the aqueous beta-glucan composition in the subterranean formation sweeps petroleum in the subterranean formation toward a well.

Aspect 62 provides the method of Aspect 61, further comprising removing the petroleum from the well.

Aspect 63 provides a use of the aqueous beta-glucan composition of any one of Aspects 1-56 for treatment of a subterranean formation.

Aspect 64 provides the apparatus, method, composition, or system of any one or any combination of Aspects 1-63 optionally configured such that all elements or options recited are available to use or select from.

1.-53. (canceled)

54. An aqueous beta-glucan composition comprising:
a beta-glucan that is about 0.001 wt % to about 5 wt % of the composition;
one or more surfactants comprising an anionic surfactant that together are about 0.01 wt % to about 5 wt % of the composition; and
salt water that is about 88 wt % to about 99 wt % of the composition;
wherein
the composition has a total dissolved solids level about 40,000 ppm o about 200,000 ppm,
at a temperature of at least one of 52°C. and 92° C., the composition is substantially free of phase separation and haziness according to visual detection for at least about 14 days, and
at a temperature of at least one of 52° C. and 92 ⁰C, and in an emulsion with crude oil, the composition has an oil solubilization ratio of 10 or more, or a water solubilization water of 10 or more, or both.

55. An aqueous beta-glucan composition comprising:
scleroglucan that is about 0.04 wt % to about 0.08 wt % of the composition;
one or more surfactants comprising an anionic surfactant that together are about 0.5 wt % to about 3 wt % of the composition; and
salt water that is about 97 wt % to about 99 wt % of the composition;
wherein
the composition has a pH of about 7 to about 8.5,
the composition has .a total dissolved solids level of about 46,000 ppm to about 71,000 ppm, and
at a temperature of at least one of 52° C. and 92° C., and in an emulsion with crude oil, the composition has an oil solubilization ratio of 10 or more, or a water solubilization water of 10 or more, or both.

56. An aqueous beta-glucan composition comprising:
scieroglucan that is about 0.04 wt % to about 0.08 wt % of the composition;
one or more surfactants comprising an anionic surfactant that together are about 0.5 wt % to about 3 wt % of the composition; and
salt water that is about 97 wt % to about 99 wt % of the composition;
wherein
the composition has a pH of about 10 to about 11,
the composition has a total dissolved solids level of about 61,000 ppm to about 66,000 ppm, and
at 92° C. and in an emulsion with crude oil the composition has an oil solubilization ratio of 10 or more, or a water solubilization water of 10 or more, or both.

57. A method of treating a subterranean formation, the method comprising:
placing the aqueous beta-glucan composition of claim 54 in the subterranean formation.

58. The method of claim 57, comprising performing a hydraulic fracturing operating in the subterranean formation using a liquid comprising the aqueous beta-glucan composition.

59. The method of claim 57, comprising performing an enhanced oil recovery procedure in the subterranean formation using a liquid comprising the aqueous beta-glucan composition.

60. The method of claim 59, wherein the enhanced oil recovery procedure comprises polymer flooding.

61. The method of claim 59, wherein the liquid comprising the aqueous beta-glucan composition in the subterranean formation sweeps petroleum in the subterranean formation toward a well.

62. The method of claim 61, further comprising removing the petroleum from the well.

63. Use of the aqueous beta-glucan composition of claim 54 for treatment of a subterranean formation.
